(19) United States
(12) Patent Application Publication
(10) Pub. No.: US 2025/0123860 A1
(43) Pub. Date: Apr. 17, 2025

(54) METHODS, APPARATUSES AND COMPUTER PROGRAM PRODUCTS FOR MENTAL MODEL AWARE EXPLAINABLE ARTIFICIAL INTELLIGENCE FOR INTELLIGENT USER INTERFACES

(71) Applicant: META PLATFORMS, INC., Menlo Park, CA (US)

(72) Inventors: Kashyap Todi, Seattle, WA (US); Tanya Renee Jonker, Seattle, WA (US); Benjamin Lafreniere, Toronto (CA); Thomas Langerak, Redmond, WA (US); Ruta Parimal Desai, Mountlake Terrace, WA (US)

(21) Appl. No.: 18/911,164

(22) Filed: Oct. 9, 2024

Related U.S. Application Data
(60) Provisional application No. 63/590,332, filed on Oct. 13, 2023.

(51) Int. Cl. G06F 9/451; G02B 27/01

(52) U.S. Cl. CPC G06F 9/451; G02B 27/017

(57) ABSTRACT

A system and method for determining content to recommend to a user interface are provided. The system may determine contexts of users within environments. The system may implement a machine learning model including training data pre-trained, or trained in real-time based on historical interactions of users with data, or determined interactions with content by the users in real time. The system may analyze an item(s) of context information associated with the contexts to determine content relevant to a user associated with the system capturing content items within an environment. The system may analyze the item(s) of context information or other items of context information to determine contextual variables, of the environments, determined as relevant to the system. The system may utilize the determined content relevant to the user and the contextual variables determined as relevant to the system to determine a recommendation(s) or action(s) to present to a user interface.

### CROSS-REFERENCE TO RELATED APPLICATIONS

This application claims priority to U.S. Provisional Application No. 63/590,332, filed Oct. 13, 2023, entitled “Mental-Model Aware Explainable Artificial Intelligence For Intelligent User Interfaces,” which is incorporated by reference herein in its entirety.

### TECHNOLOGICAL FIELD

Exemplary aspects of this disclosure may relate generally to methods, apparatuses and computer program products to facilitate user interface optimization and for providing explainable artificial intelligence contextual adaptive user interfaces.

### BACKGROUND

Currently, intelligent user interfaces (IUIs) may deliver timely, relevant, and personalized experiences to users across diverse use cases. Some IUIs, while more user-friendly than rule-based systems, may often lack transparency. This may catch users off guard, resulting in increased frustration, increased task time, and reduced trust. For instance, the approaches of some current IUIs typically neglect to consider a user's knowledge and assumptions about a system's behavior. In this regard, these current systems typically lack mechanisms to determine how much an interface should explain about a system's models and decisions. Additionally, bombarding users with excessive or non-essential details may be counterproductive and cumbersome to users.

As such, it may be beneficial to provide efficient and reliable mechanisms that provide enhanced techniques to determine which contextual variables should be included in an explanation(s) to user interfaces.

### BRIEF SUMMARY

Some example aspects of the present disclosure may facilitate advancements in user interface optimization and explainable artificial intelligence for adaptive user interfaces. As such, some example aspects of the present disclosure may provide systems, methods and/or approaches that may determine the mental awareness of users with regard to contexts associated with the users and may utilize the determined contexts to determine relevant and timely explanations and recommendations for adaptations provided/presented via user interfaces.

In this regard, some examples of the present disclosure may provide mental-model aware explainable artificial intelligence (AI) for contextual adaptive user interfaces. The exemplary aspects of the present disclosure may utilize sensitivity analyses to determine the importance of contextual variables to facilitate explainable AI user interfaces. The exemplary aspects may determine criteria such as for example which contextual variables a user(s) may be wrong or unsure about, which contextual variables may be important to user(s) and, in some examples, whether a user(s) is likely to be surprised by an adaptation(s) that may be provided to a user interface. The criteria may be provided for analysis by an optimization scheme of a system of the present disclosure to enable the system to determine dense explanations in a high-dimensional environment to provide to an adaptive user interface.

In one example aspect of the present disclosure, a method is provided. The method may include determining one or more contexts of one or more users within one or more environments. The method may include implementing a machine learning model including training data pre-trained, or trained in real-time based on historical interactions of one or more other users with data, or determined interactions with content by the one or more other users in real time. The method may include analyzing at least one item of context information associated with the one or more contexts to determine content relevant to a user associated with an apparatus capturing content items within an environment. The environment may be an environment of the one or more environments. The method may include analyzing the at least one item of context information or other items of context information to determine, by implementing the machine learning model, one or more contextual variables, of the one or more environments, determined as relevant to the apparatus. The method may include utilizing the determined content relevant to the user and the determined one or more contextual variables determined as relevant to the apparatus to determine at least one recommendation or action to present to a user interface. The user interface may be a user interface of the apparatus.

In another example aspect of the present disclosure, an apparatus is provided. The apparatus may include one or more processors and a memory including computer program code instructions. The memory and computer program code instructions are configured to, with at least one of the processors, cause the apparatus to at least perform operations including determining one or more contexts of one or more users within one or more environments. The memory and computer program code are also configured to, with the processor(s), cause the apparatus to implement a machine learning model including training data pre-trained, or trained in real-time based on historical interactions of one or more other users with data, or determined interactions with content by the one or more other users in real time. The memory and computer program code are also configured to, with the processor(s), cause the apparatus to analyze at least one item of context information associated with the one or more contexts to determine content relevant to a user associated with an apparatus capturing content items within an environment. The environment may be an environment of the one or more environments. The memory and computer program code are also configured to, with the processor(s), cause the apparatus to analyze the at least one item of context information or other items of context information to determine, by implementing the machine learning model, one or more contextual variables, of the one or more environments, determined as relevant to the apparatus. The memory and computer program code are also configured to, with the processor(s), cause the apparatus to utilize the determined content relevant to the user and the determined one or more contextual variables determined as relevant to the apparatus to determine at least one recommendation or action to present to a user interface. The user interface may be a user interface of the apparatus.

In yet another example aspect of the present disclosure, a computer program product is provided. The computer program product may include at least one non-transitory computer-readable medium including computer-executable program code instructions stored therein. The computer-executable program code instructions may include program code instructions configured to determine one or more contexts of one or more users within one or more environments. The computer program product may further include program code instructions configured to implement a machine learning model including training data pre-trained, or trained in real-time based on historical interactions of one or more other users with data, or determined interactions with content by the one or more other users in real time. The computer program product may further include program code instructions configured to analyze at least one item of context information associated with the one or more contexts to determine content relevant to a user associated with an apparatus capturing content items within an environment. The environment may be an environment of the one or more environments. The computer program product may further include program code instructions configured to analyze the at least one item of context information or other items of context information to determine, by implementing the machine learning model, one or more contextual variables, of the one or more environments, determined as relevant to the apparatus. The computer program product may further include program code instructions configured to utilize the determined content relevant to the user and the determined one or more contextual variables determined as relevant to the apparatus to determine recommendation or action to present to a user interface. The user interface may be a user interface of the apparatus.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4 illustrates an example of an artificial reality system comprising a headset, in accordance with an example of the present disclosure.

FIG. 5 illustrates another artificial reality system comprising a headset, in accordance with an example of the present disclosure.

FIG. 6 is a diagram illustrating an exemplary environment in which a mental model aware explainable artificial intelligence contextual adaptive user interface is provided in accordance with exemplary aspects of the present disclosure.

FIG. 7 is a diagram illustrating components to determine a linear optimization that may be utilized to determine explanations for provision to user interfaces in accordance with exemplary aspects of the present disclosure.

FIG. 8 is a diagram illustrating suggested or recommended contextual variables for presentation by a user interface in accordance with exemplary aspects of the present disclosure.

FIG. 9 illustrates an example of a machine learning framework in accordance with one or more examples of the present disclosure.

FIG. 10 illustrates an example flowchart illustrating operations for determining actions, recommendations, and/or explainable content to provide to an adaptable user interface in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary”, as used herein, is not provided to convey any qualitative assessment, but instead merely to convey an illustration of an example. Thus, use of any such terms should not be taken to limit the spirit and scope of embodiments of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, a mental model(s) may refer to a user's understanding and expectations about the state of the world, the state of a system (e.g., an artificial reality system) they are interacting with, and/or their understanding of what led the system to exhibit certain behavior.

As referred to herein, a dynamic user interface, an adaptable user interface, a contextual adaptive user interface or an explainable artificial intelligence (XAI) user interface may refer to a tailored user interface that may be specific to a user(s) and/or their current context(s), and that may dynamically present content items (e.g., user specific content) to the user interface in real-time.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

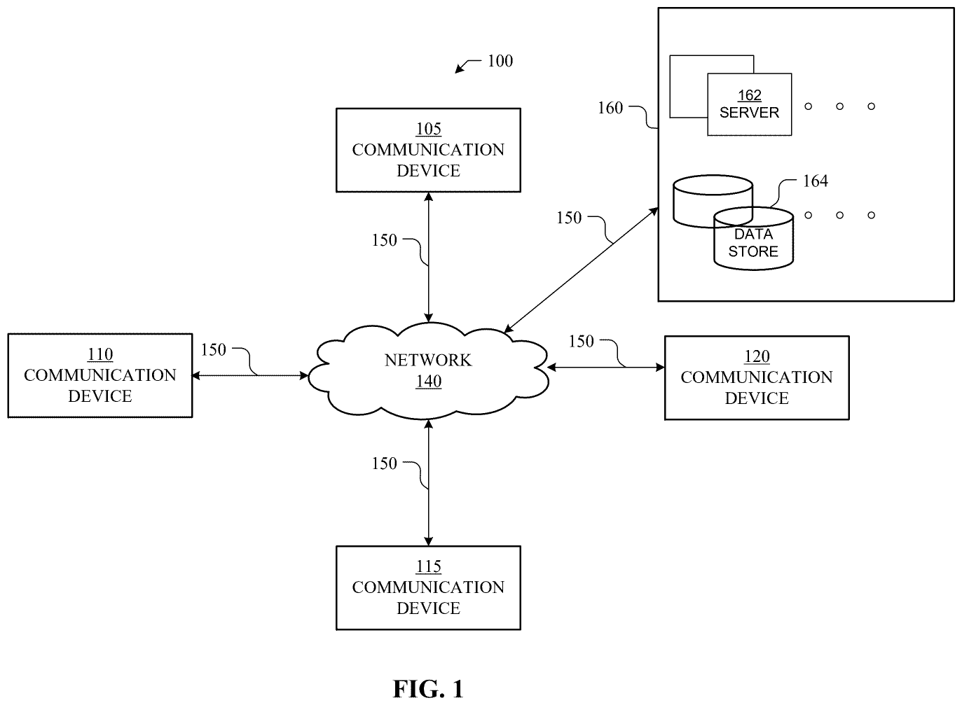

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

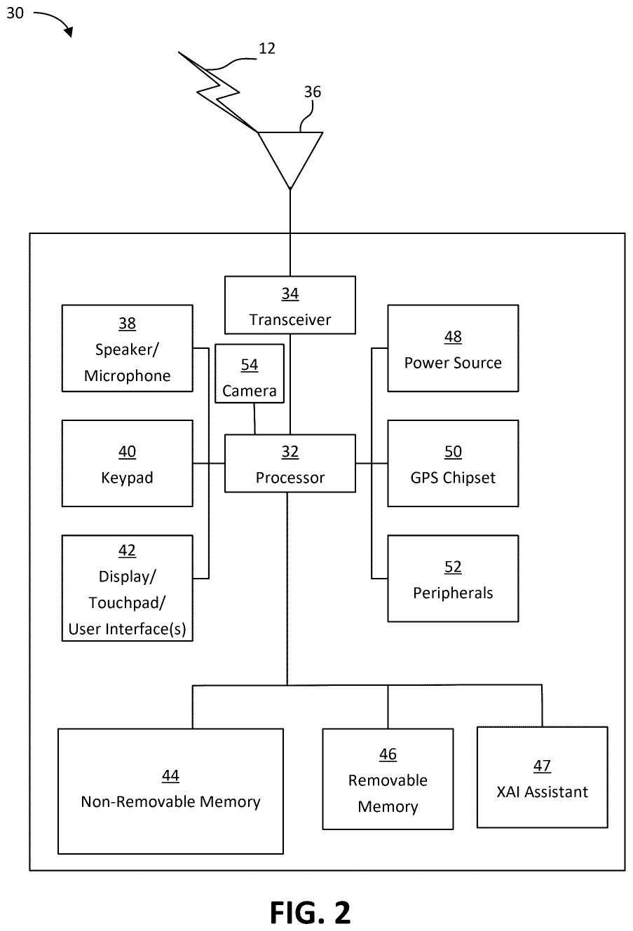

FIG. 2 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, a head-mounted display/device (e.g., a headset), smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or user interface(s) 42, a power source 48, a global positioning system (GPS) chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

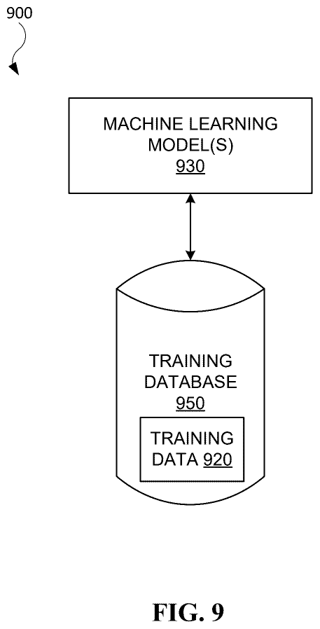

The UE 30 may further include an explainable AI (XAI) assistant 47 that may provide novel integer linear optimization techniques that facilitate dynamically determining which contextual details to present to users via adaptable user interfaces (e.g., display/touchpad/user interface(s) 42). The XAI assistant 47 of the example aspects may provide explanations that provide accurate insights into key factors that enable determining one or more recommendations for provision/presentation to adaptable user interfaces. In some examples, the XAI assistant 47 may implement a machine learning model (e.g., machine learning model(s) 930 of FIG. 9) and/or an AI model that may be pre-trained, trained in real-time, and/or periodically trained with training data (e.g., training data 920 of FIG. 9) to enable determining one or more recommendations, actions and/or explanations for provision/presentation to adaptable user interfaces, as described more fully below.

The XAI assistant 47 may utilize sensors (e.g., camera 54, GPS chipset 50, processor 32, etc.) of the UE 30 to facilitate understanding of contexts (e.g., contextual information/variables) of users of the UE 30 and the users' current states and their environments to provide a variety of intelligent functionality to user interfaces (e.g., display/touchpad/user interface(s) 42). By using the determined understanding and contextual information associated with users, the XAI assistant 47 may determine user intent and provide contextual recommendations, actions and/or explanations to a user interface(s). In some other example aspects, the XAI assistant 47 may communicate the contextual recommendations, actions and/or explanations to an audio device (e.g., speaker/microphone 38) to enable the audio device to output the contextual recommendations, actions and/or explanations as audio content and/or may also display/present the contextual recommendations, actions and/or explanations via the user interface.

In some examples, these rich contents of determined user understanding and/or user contextual information may support users by providing recommendations, actions and/or explanations in a variety of contexts such as when users may be confused or surprised in an environment(s) while encountering an unexpected AI outcome(s) presented to a user interface and/or in instances in which users may want to ensure that an AI outcome(s) presented to a user interface is reliable and/or trustworthy.

### Exemplary Computing System

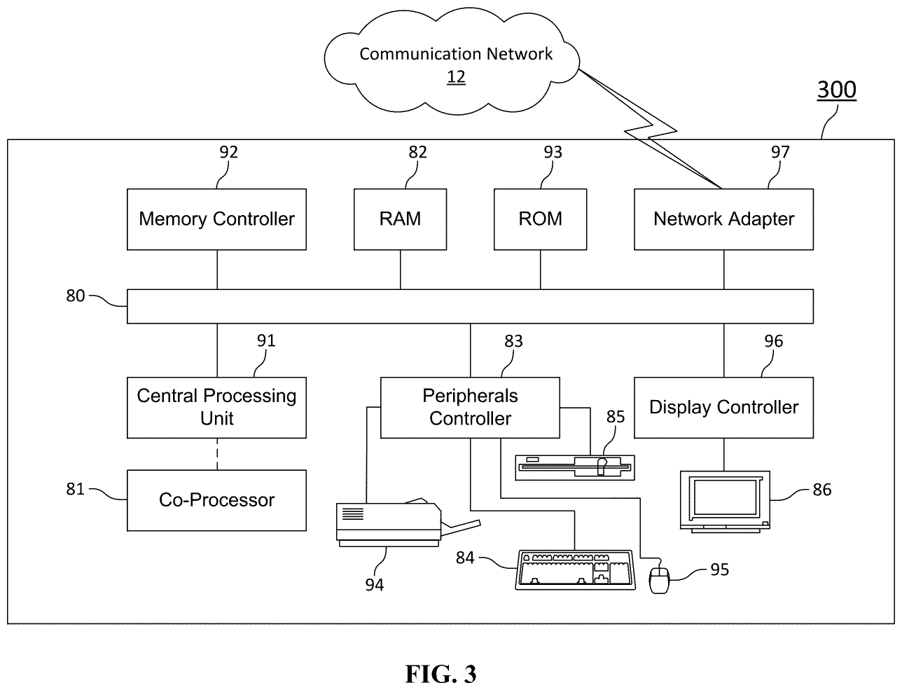

FIG. 3 is a block diagram of an exemplary computing system 300. In some exemplary embodiments, the network device 160 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

### Exemplary Artificial Reality System

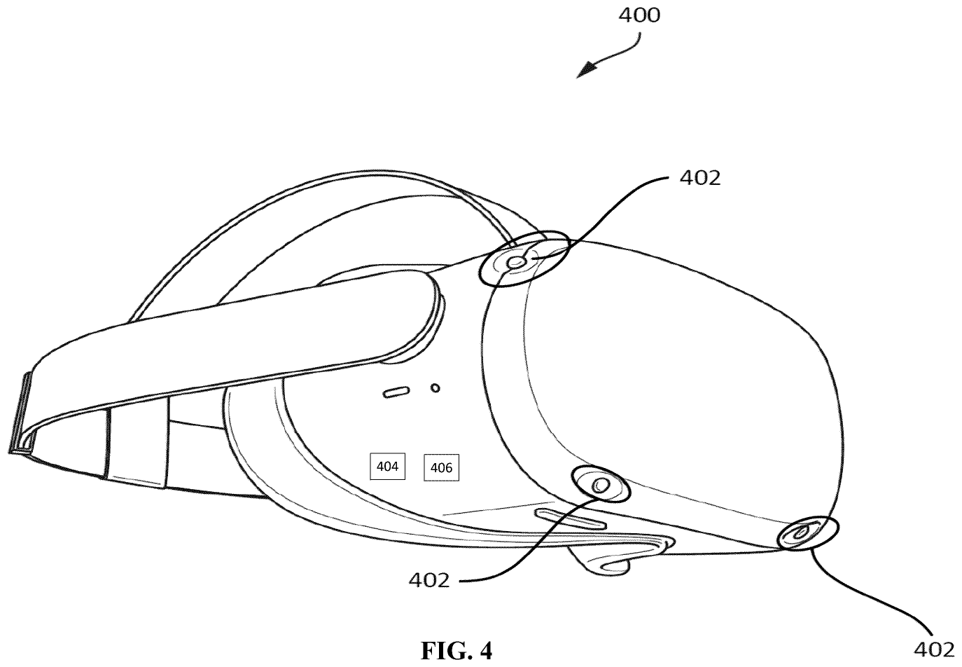

FIG. 4 illustrates another example of an artificial reality system including a head-mounted display (HMD) 400, image sensors 402 mounted to (e.g., extending from) HMD 400, according to at least one example aspect of the present disclosure. In some examples of the present disclosure, the HMD 400 may be an example of artificial reality system 500 and/or HMD 510. In some example aspects, image sensors 402 may be mounted on and protruding from a surface (e.g., a front surface, a corner surface, etc.) of HMD 400. In some exemplary aspects, HMD 400 may include an artificial reality system/virtual reality system. In an exemplary aspect, image sensors 402 may include, but are not limited to, one or more sensors (e.g., cameras 516, 518, a display 514, an audio device 506, etc.), a memory 406 (e.g., RAM, ROM) and a processor 404 (e.g., a controller (e.g., controller 504)). In exemplary embodiments, a compressible shock absorbing device may be mounted on image sensors 402. The shock absorbing device may be configured to substantially maintain the structural integrity of image sensors 402 in case an impact force is imparted on image sensors 402. In some exemplary embodiments, image sensors 402 may protrude from a surface (e.g., the front surface) of HMD 400 so as to increase a field of view of image sensors 402. In some examples, image sensors 402 may be pivotally and/or translationally mounted to HMD 400 to pivot image sensors 402 at a range of angles and/or to allow for translation in multiple directions, in response to an impact. For example, image sensors 402 may protrude from the front surface of HMD 400 so as to give image sensors 402 at least a 180 degree field of view of objects (e.g., a hand, a user, a surrounding real-world environment, etc.).

### Another Exemplary Artificial Reality System

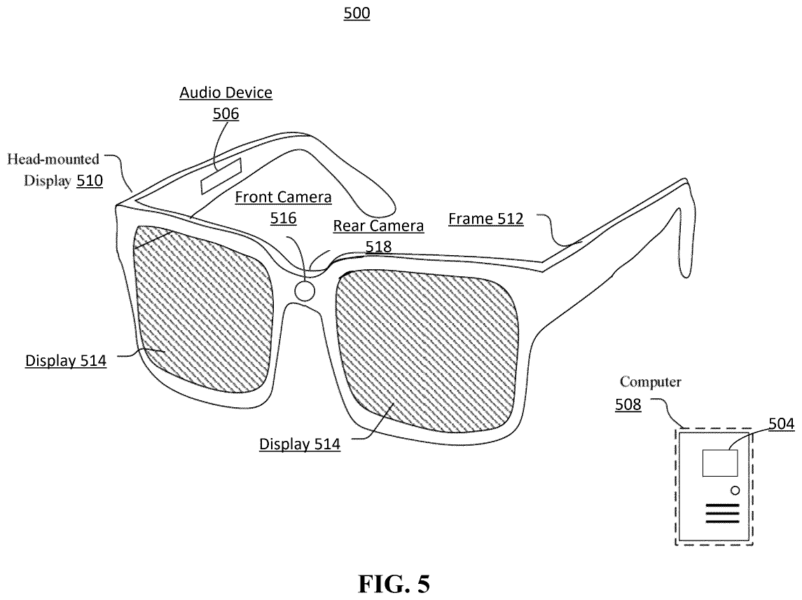

FIG. 5 illustrates an example artificial reality system 500. The artificial reality system 500 may include a head-mounted display (HMD) 510 (e.g., smart glasses and/or augmented/virtual reality device) comprising a frame 512, one or more displays 514, a computing device 508 (also referred to herein as computer 508) and a controller 504. In some examples, the HMD 510 may capture one or more items of text from one or more images/videos associated with a real world environment in the field of view of one or more cameras (e.g., cameras 516, 518) of the artificial reality system 500. The HMD 510 may utilize the captured text from the one or more images/videos to trigger one or more actions/functions by the artificial reality system 500. The displays 514 may be transparent or translucent allowing a user wearing the HMD 510 to look through the displays 514 to see the real world (e.g., real world environment) and displaying visual artificial reality content to the user at the same time. The HMD 510 may include an audio device 506 (e.g., speakers/microphones) that may provide audio artificial reality content to users. The HMD 510 may include one or more cameras 516, 518 which may capture images and/or videos of environments. In one exemplary embodiment, the HMD 510 may include a camera(s) 518 which may be a rear-facing camera tracking movement and/or gaze of a user's eyes.

One of the cameras 516 may be a forward-facing camera capturing images and/or videos of the environment that a user wearing the HMD 510 may view. The camera(s) 516 may also be referred to herein as a front camera(s) 516. The HMD 510 may include an eye tracking system to track the vergence movement of the user wearing the HMD 510. In one exemplary embodiment, the camera(s) 518 may be the eye tracking system. In some exemplary embodiments, the camera(s) 518 may be one camera configured to view at least one eye of a user to capture a glint image(s) (e.g., and/or glint signals). The camera(s) 518 may also be referred to herein as a rear camera(s) 518. The HMD 510 may include a microphone of the audio device 506 to capture voice input from the user. The artificial reality system 500 may further include a controller 504 comprising a trackpad and one or more buttons. The controller 504 may receive inputs from users and relay the inputs to the computing device 508. The controller 504 may also provide haptic feedback to one or more users. The computing device 508 may be connected to the HMD 510 and the controller 504 through cables or wireless connections. The computing device 508 may control the HMD 510 and the controller 504 to provide the augmented reality content to and receive inputs from one or more users. In some example embodiments, the controller 504 may be a standalone controller or integrated within the HMD 510. The computing device 508 may be a standalone host computer device, an on-board computer device integrated with the HMD 510, a mobile device, or any other hardware platform capable of providing artificial reality content to and receiving inputs from users. In some exemplary embodiments, the HMD 510 may include an artificial reality system/virtual reality system.

### Exemplary System Operation

Some example aspects of the present disclosure may provide explainable artificial intelligence approaches that address challenges around predictability and interpretability of intelligent user interfaces (IUIs). The explainable artificial intelligence approaches may enable users to understand why an IUI made a particular adaptation(s) and/or recommendation for a user interface in a given context, in which context may refer to some aspect of a user or the user's environment (e.g., current location, activity, weather, etc.).

Examples of the present disclosure may provide novel integer linear optimization techniques that dynamically determines which contextual details to present to users via adaptable user interfaces. The systems of the example aspects of the present disclosure may balance the usefulness of explanations for provision to adaptable user interfaces against the length and/or quantity of the explanations. The systems of the example aspects may provide explanations that provide accurate insights into key factors that enable determining one or more recommendations, actions and/or explanations for provision/presentation to adaptable user interfaces. Some existing IUIs typically may neglect to consider a user's knowledge and assumptions about a system's behavior. In contrast to some existing IUIs, the systems of the example aspects of the present disclosure may determine factors (e.g., contextual factors/variables) such as user surprise, differences between one or more users perceived context and the context determined by the systems, and may determine which factors influenced the systems determination of suggestions and/or recommendations.

Additionally, some existing IUI systems may not consider a user's mental model of the system, which may be based on the user's knowledge and expertise, prior interactions of the user with the system, and/or observations of the current context. As such, explanations may have reduced benefits when they may not provide users with new insights or may not explain unexpected factors that influenced the system's adaptation or recommendation. The systems of the example aspects of the present disclosure may present a novel approach to address these issues in which explanations may be adapted and optimized based on both the underlying system model that drives IUI behavior and a user's inferred mental model.

A sensitivity analysis technique may be provided by some example aspects of the present disclosure to determine/estimate the impact of any context factor(s) on XAI and/or a machine learning (ML) model's (e.g., machine learning model(s) 930) recommendation output and a determined mental model of a user to infer/determine what the user is likely to know and expect. By integrating these components into an integer linear optimization, the example aspects may provide an intelligent interactive system and may select the most relevant context factors to provide to a user(s) as recommendations, actions, and/or explanations, thus ensuring that the user(s) may gain valuable insights without being overwhelmed with too much information presented by a user interface (e.g., an adaptable user interface).

The example aspects of the present disclosure may provide more relevant explanations via adaptable user interfaces than some existing IUIs that may not provide explanations. Furthermore, by utilizing exemplary aspects of the present disclosure, no decrease may be determined in providing user understandable explanations and the complexity of providing explanations may be reduced. Additionally, the example aspects of the present disclosure may provide higher levels of trust in its systems and an improved ability to predict context-to-adaptation mappings.

The example aspects of the present disclosure may provide an AI and/or machine learning model-based approach that predicts/determines the most useful items of information regarding an environment(s) a user is within/experiencing as explanations and/or recommendations to the user that may minimize the user's surprise about the predictions by the AI and/or the ML model implemented by a system and may also consider/determine the user's mental model associated with the system (e.g., referred to herein, in some examples, as a mental model-aware explainable AI).

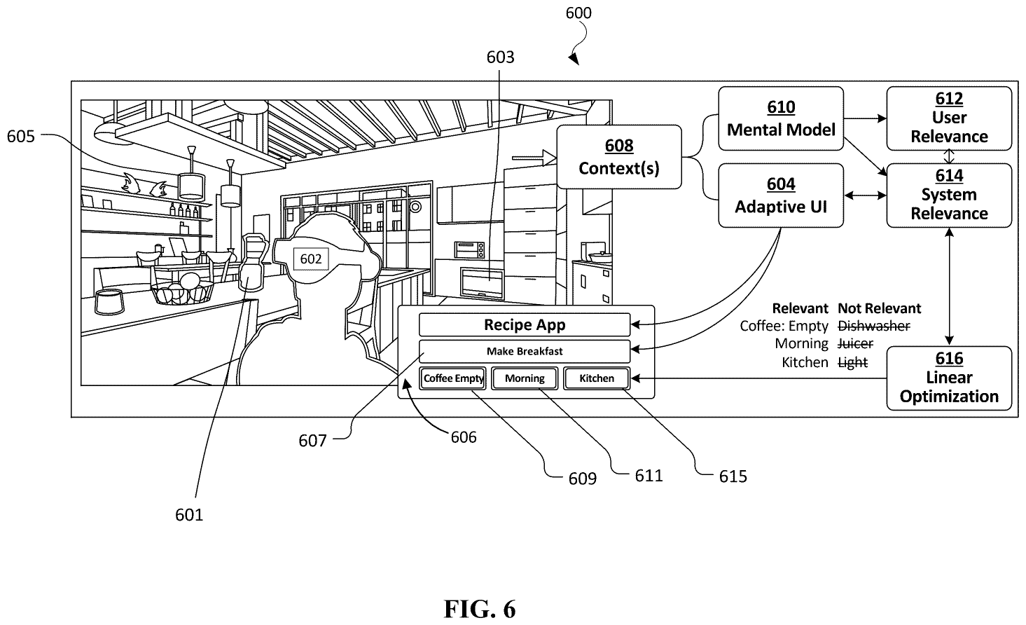

Referring now to FIG. 6, a diagram illustrating an exemplary environment in which a mental model aware explainable artificial intelligence contextual adaptive user interface is provided in accordance with example aspects of the present disclosure. In the example of FIG. 6, a user may wear, or otherwise be associated with, an artificial reality system 602 (e.g., artificial reality system 500) such as for example HMD 400 or HMD 510 and the user may maneuver (e.g., move about) the environment 600. For purposes of illustration and not of limitation, in the example of FIG. 6, the environment may be a kitchen. In other examples, the environment may be any other suitable real-world environment (e.g., an office, a store, an arena, an outside area (e.g., a city, a mountain(s), an ocean(s)), etc.).

In the example of FIG. 6, an XAI assistant (e.g., XAI assistant 47) of the artificial reality system may present an application (app) such as, for example, a recipe app 604 to an adaptive user interface 606 (e.g., an XAI user interface (e.g., display 514, display/touchpad/user interface(s) 42)) of the artificial reality system 602. In the example of FIG. 6, the recipe app 606 may be provided/presented via the adaptive user interface (UI) 604.

Further, in the example of FIG. 6 the XAI assistant (e.g., XAI assistant 47 (e.g., machine learning model(s) 930)) may determine a context(s) 608 associated with the user in the environment 600. The context(s) 608 may be determined by the XAI assistant based on one or context items determined by the XAI assistant which may be based on data received from one or more sensors (e.g., cameras (e.g., cameras 516, 518), audio device (e.g., audio device 506), GPS chipset 50, a processor(s) (e.g., processor 404, controller 504), etc.) of the artificial reality system 602. In this regard, for example, the cameras may provide one or more captured images/videos of a field of view of the artificial reality system 602, the audio device may provide audio content associated with the environment 600, and/or the GPS chipset 50 may provide a determined location and/or movement/motion associated with the artificial reality system 602 to the to the XAI assistant as the context(s) 608. Additionally, in some example aspects, the processor may provide information (e.g., content determined from a network (e.g., weather information, time information, other information, etc.)) to the XAI assistant as the context(s) 608.

The XAI assistant may access and/or receive information from other sensors such as, for example, smart devices (e.g., coffee maker 601, dishwasher 603, a light(s) 605, etc.). In this regard, for example the XAI assistant may access or receive information from smart devices such as regarding whether the coffee maker 601 is empty or full of coffee, whether the dishwasher 603 is empty or full of dishes, whether one or more lights (e.g., light(s) 605) are on or off and any other suitable information.

In response to the XAI assistant accessing or receiving the information associated with the context(s) 608, the XAI assistant may provide/feed the information of the context(s) 608 to a mental model component 610 (e.g., an AI subcomponent and/or a ML subcomponent of the XAI assistant) of the XAI assistant. In some examples, the mental model component 610 may be referred to herein as mental model 610. In some example aspects of the present disclosure, the mental model 610 may include, or may be associated with, a user relevance component 612 and a system relevance component 614. In some aspects of the present disclosure, the user relevance component 612 may be referred to herein as user relevance 612 and the system relevance component 614 may be referred to herein as system component 614. The user relevance 612 and the system relevance 614 may be an AI subcomponent and/or a ML subcomponent of the mental model 610.

In the example of FIG. 6, the system relevance 614 may analyze the information of the context(s) 608 provided by the mental model 610, and in this example may determine system contextual data from the context(s) 608 indicating/denoting that the coffee maker 601 is empty and has no coffee, that the time of day is currently morning, and that the location of the user is in the kitchen of the environment 600, etc. The system relevance 614 may analyze the system context information and may utilize this information to determine/predict which one or more actions or recommendations may be the best action(s)/recommendation(s) to provide to the artificial reality system 602 of the user.

In this example, the system relevance 614 may utilize the system contextual data (e.g., empty coffee maker 601, and morning time of day, etc.) to determine an action(s) such as, for example, presenting/providing the recipe app 606 to the adaptive UI 604 of the artificial reality system 602 to enable or prompt the user to choose to open/select the recipe app 606. For instance, in this example, the system relevance 614 may determine that the user may want to be provided the recipe app 606 to be able to utilize the recipe app 606 to perform a determined action(s)/recommendation(s). The system relevance 614 may be designated to determine a best action(s)/recommendation(s) for a user(s) based on a standpoint(s)/perspective(s) of the artificial reality system 602. In the example of FIG. 6, the system relevance 614 may determine a best action(s)/recommendation(s) for the user such as, for example, Make Breakfast 607 based on a standpoint(s)/perspective(s) of the artificial reality system 602 of the user. The system relevance 614 may utilize the system contextual data (e.g., empty coffee maker 601, morning time, location of the user is in a kitchen, etc.) associated with the context(s) 608 to determine the best action(s)/recommendation(s) Make Breakfast 607.

As described above, in predicting/determining an action(s) and/or recommendation(s), the system relevance 614 may analyze/check the system contextual data to determine which context factors may be relevant to determining a particular recommendation (e.g., recommendation to provide the recipe app 606) and/or to a particular action(s) being proposed to the user of the artificial reality system 602.

In this regard, by analyzing the system contextual data, the system relevance 614 may determine to propose an action(s) of the recipe app 606 presented via the adaptive UI 604 to Make Breakfast 607. To determine the particular action to Make Breakfast 607, the system relevance 614 may analyze all, or a subset of, the different context variables to determine whether the context variables are relevant or not relevant. As shown in FIG. 5, the system relevance 614 determined that relevant context variables were coffee empty, it's morning and kitchen and that content variables associated with light (e.g., light(s) 605) and the dishwasher (e.g., dishwasher 603) as well as a juicer were not relevant for the artificial reality system 602 to provide associated information to the user. The context variables identified/determined as relevant may be a set of factors (e.g., context factors) that the system relevance 614 determines may be currently relevant for the artificial reality system 600 to utilize to make a determination regarding one or more explanations to provide/present via the adaptive UI 604 to the user.

The user relevance 612 may analyze the information of the context(s) 608 provided by the mental model 610, and in this example may determine user contextual data from the context(s) 608 indicating/denoting that the coffee maker 601 is empty and has no coffee, that the time of day is currently morning, and that the location of the user is in the kitchen of the environment 600, etc.

The user relevance 612 may make a determination/prediction about what is known (e.g., aware) by the user of the artificial reality system 600 and what may be unknown (e.g., unaware) by the user. For example, the user relevance 612 may make a determination that the user of the artificial reality system 602 knows that a dishwasher 603 is full of dishes, that a juicer is turned on and that a light(s) 605 is turned on. For purposes of illustration and not of limitation, for example, the user may know that the dishwasher 603 is full of dishes and that the juicer and the light(s) 605 are turned on based on capturing an image(s) and/or a video(s) of the dishwasher 603, the juicier and the light(s) 605 in a field of view of the artificial reality system, either in the present moment or during some past interaction (e.g., the user viewing the dishwasher while wearing the artificial reality system at an earlier time). As such, the user relevance 612 may determine that information (e.g., contextual information) regarding the dishwasher 603, the juicer and the light(s) 605 may not be relevant (e.g., irrelevant) to present/provide to the adaptive UI 604. In this regard, the information (e.g., contextual information) pertaining to the dishwasher 603, the juicer and the light(s) 605 may not be beneficial to inform the user. Accordingly, the user relevance 612 may exclude the information regarding the dishwasher 603, the juicer and the light(s) 605 from being provided/presented as an explanation(s) to the adaptation UI 604.

On the other hand, in the example of FIG. 6, the user relevance 612 may determine that the user of the artificial reality system 602 may not know (e.g., unaware) that the coffee maker 601 is empty because the user's friend already drank all the prior brewed coffee and the drinking of all the prior brewed coffee is something unknown to the user in this example. For instance, the user's friend may have awaken much earlier than the user and drank all the prior brewed coffee brewed by the coffee maker 601 such the that coffee maker 601 is currently empty. As such, the user relevance 612 may determine that the coffee maker 601 being empty of coffee is relevant to the user since the time of day is morning and in view of the environment 600 that the user is within is a kitchen. In this regard, the user relevance 612 may determine that the coffee maker being empty of coffee is user relevant as well as system relevant, as determined by the system relevance 614 in the manner described above, and as such the indication of Coffee Empty 609 may be provided as an explanation(s) to the recipe app 606 and presented/provided via the adaptive UI 604 for display to, and/or interaction by, the user of the artificial reality system 602. In the example of FIG. 6, Morning (e.g., Morning 611) and Kitchen (e.g., Kitchen 615) may be added/included as explanations to the recipe app 606 since the system relevance 614 may determine that Morning and Kitchen are relevant to the recommendation (e.g., Make Breakfast 607). The Morning 611 and Kitchen 615 explanations may be arranged/located after the Coffee Empty 609 explanation(s) as the Morning 611 and Kitchen 615 explanations may not be both user relevant as well as system relevant (e.g., the user knows it is morning and the user is aware the user is located in the kitchen).

The linear optimization component 616 may be a AI component and/or ML component of the XAI assistant (e.g., XAI assistant 47). In some example aspects, the linear optimization component 616 may be referred to herein as linear optimization 616. The linear optimization 616 may determine optimizations regarding the most beneficial and/or best information to provide to the adaptive UI 604. In some examples, the linear optimization 616 may determine a score(s) or ranking(s) associated with items of contextual data (e.g., based on the context(s) 608). Based on the determined scores/rankings, the linear optimization 616 may determine the best content to provide to the adaptive UI 604. In some examples of the present disclosure, information associated with scores or rankings, determined by the linear optimization 616, that equal or exceed a predetermined threshold may be deemed the best/beneficial content to provide/present via the adaptive UI 604.

In some other examples of the present disclosure, a predetermined number of recommendations or explanations may be provided (e.g., based on which content may fit within a user interface such as adaptive UI 604), based on the highest scored or highest ranked items being selected by the linear optimization 616. In this example, there may be a fixed space for recommendations or explanations in a user interface (e.g., adaptive UI 604), and the linear optimization 616 may utilize ranking/scoring to determine which content items to provide within the user interface which may have the fixed space or limited space for content.

In some examples of the present disclosure, the linear optimization 616 may analyze the contextual information (e.g., described above) associated with the context(s) 608 determined by the user relevance 612 and the system relevance 614 and may determine which items of contextual information are relevant and which are not relevant (e.g., irrelevant). In the example of FIG. 6, by analyzing the contextual information determined/output by the user relevance 612 and the system relevance 614, the linear optimization 616 may determine that the contextual information associated with Coffee: Empty, Morning and Kitchen are relevant and that contextual information associated with Dishwasher, Juicer and Light are not relevant. The linear optimization 616 may provide/output of the determined relevant contextual information to the adaptive UI 604 as explanations. For instance, in the example of FIG. 6, the linear optimization 616 may provide the determined relevant contextual information to the recipe app 606 as explanations such as Coffee Empty 609, Morning 611 and Kitchen 615 as explanation data.

In some example aspects, in an instance in which the user may not make a selection of an input (e.g., Make a Breakfast 607 recommendation, Coffee Empty 609, Morning 611, Kitchen 615 explanations) from the recipe app 606 within a predetermined time period (e.g., expiration of 3 minutes, expiration of 5 minutes, etc.) of the recipe app 606 being presented via the adaptive UI 604, the recipe app 606 may be removed from the adaptive UI 604 and/or an associated display (e.g., display 514) of the artificial reality system 602. In this regard, the adaptive UI 604 may be presented other content suggestions/recommendations by the XAI assistant as the user wearing the artificial reality system 602 moves about the same environment (e.g., a kitchen) or different environments.

In another alternative example, the XAI assistant may remove the recipe app 606 from the adaptive UI 604 in response to receipt of a detection of a trigger(s) by the user to be presented with new recommendations regarding the environment (e.g., environment 600) or a different environment the user may be within. Some examples of the trigger(s) may be a selection/tap of an input (e.g., a button) on the artificial reality system 602 and/or a detected eye gaze associated with real-world content of the environment being viewed by the user.

On the other hand, in an instance in which the user makes a selection of the input from the recipe app 606 before the recipe app 606 is removed from, or unviewable via, the adaptive UI 604, the XAI assistant may automatically present other recommendations via the adaptative UI 604. For example, in an instance in which the user selects the Make a Breakfast 607 recommendation, the adaptive UI 604 may automatically present one or more recipes for breakfast items (e.g., pancakes) to the user via the adaptive UI 604.

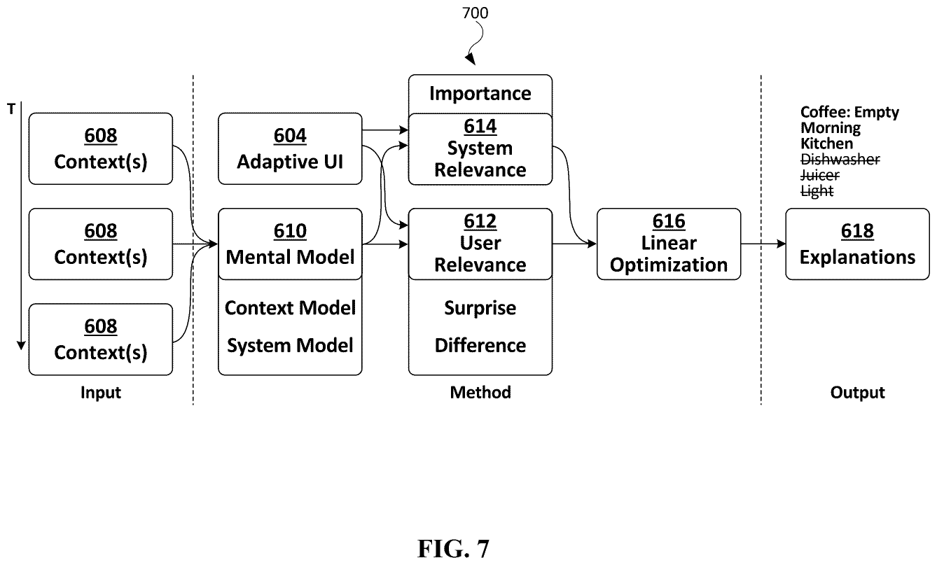

Referring now to FIG. 7, a diagram illustrating components to determine a linear optimization that may be utilized to determine explanations for provision to user interfaces in accordance with exemplary aspects of the present disclosure is provided. The system 700 of FIG. 7 may include three categories of components: 1) models, 2) metrics, and 3) optimization(s). The context (e.g., context(s) 608) may be input to the models, the models may result in metrics, the metrics may be used for optimizations, for example determined by linear optimization 616, and the linear optimization may output explanations (e.g., explanations 618) in terms of the contextual variables (e.g., contextual information). An example of the explanations 618 may be Coffee Empty 609, Morning 611 and Kitchen 615. A first model of the system 700 may be an Adaptive User Interface policy that may be trained using data from a data collection user study. The Adaptive User Interface policy may be associated with contextual variables (e.g., important contextual variables) for an adaptive user interface (e.g., adaptive UI 604).

A second model may be a Bayesian-based mental model (e.g., mental model 610). Other models of the system 700 may include the user relevance 612 and the system relevance 614. At least three cost functions or metrics associated with system 700 may include, but are not limited to, the importance of a variable(s), the likelihood that a user is surprised by an adaptation(s), and the difference between the user and system in terms of a contextual inference(s). The linear optimization (e.g., linear optimization 616) may be utilized with constraints to generate the explanations (e.g., explanations 618).

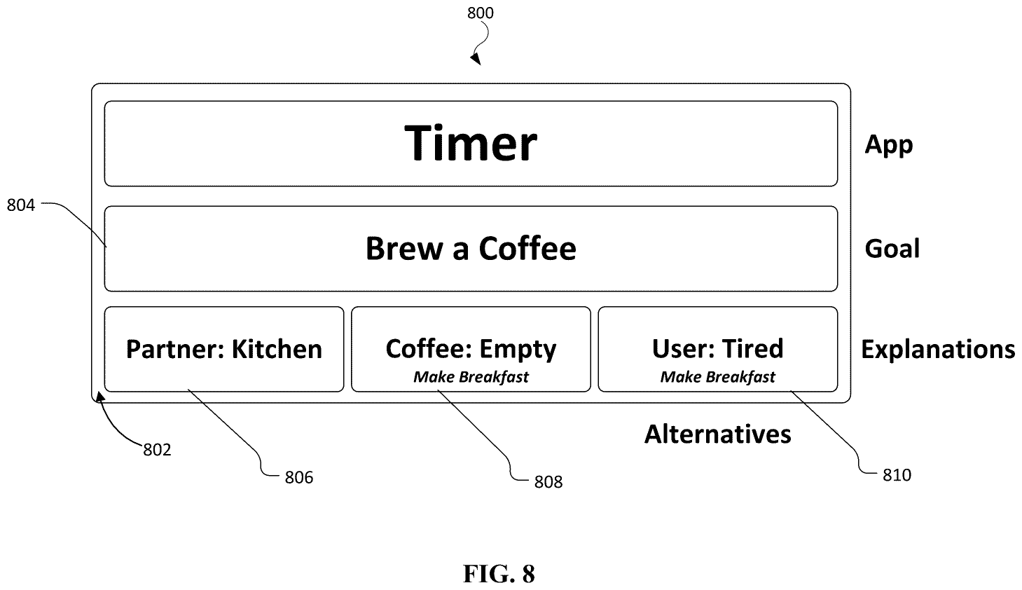

Referring now to FIG. 8, a diagram illustrating suggested or recommended contextual variables for presentation by a user interface is provided in accordance with example aspects of the present disclosure. In the example of FIG. 8, the recommendations 800 may be determined by an XAI assistant (e.g., XAI assistant 47) and may be provided to and/or presented via an adaptable UI (e.g., adaptive UI 604).

In the example of FIG. 8, the XAI assistant of an artificial reality system (e.g., artificial reality system 602) may generate a recommendation/suggestion such as a timer app 802. The XAI assistant may generate the recommended timer app 802 based on detecting a context(s) and contextual information associated with an environment (e.g., a kitchen) within which a user wearing the artificial reality system may be within.

Based on evaluating the context(s) (e.g., a coffee maker is empty, time of day is morning, etc.), the system relevance 614 may determine that generating an action(s)/recommendation(s) such as for example Brew Coffee may be beneficial to the user and may provide the Brew a Coffee 804 action(s)/recommendation(s) to the timer app 802 for presentation via the adaptive UI.

In response to a mental model (e.g., mental model 610) providing a context(s) (e.g., context(s) 608) and the user relevance component (e.g., user relevance 610) and the system relevance component (e.g., system relevance 614) analyzing contextual variables associated with the context(s), a linear optimization (e.g., linear optimization 616) may determine one or more explanations. The explanations may be output and provided within the timer app 802. The explanations determined by the linear optimization may also be referred to herein as explainable data. In the example of FIG. 8, the explanations determined by the linear optimization may be Partner: Kitchen 806, Coffee: Empty 808 and User: Tired 810. The explanation Coffee: Empty 808 may also include alternative explanation data such as Make Breakfast and the explanation User: Tired 810 may include alternative explanation data such as Make Breakfast.

In the example of FIG. 8, the user relevance component (e.g., user relevance 612) may have determined that the partner of the user of the artificial reality system was previously in the kitchen and that the coffee maker is empty, and as such the user relevance component may determine that contextual variables such as partner: kitchen and coffee: empty may be relevant to the user even though the user of the artificial reality system may be unaware of the partner being in the kitchen and the coffee maker being empty in real-time as these events occurred. For purposes of illustration and not of limitation, the user relevance component may, as an example, determine that these contextual variables are user relevant to the user since a time of day may be morning and the user may want to brew coffee and/or make breakfast.

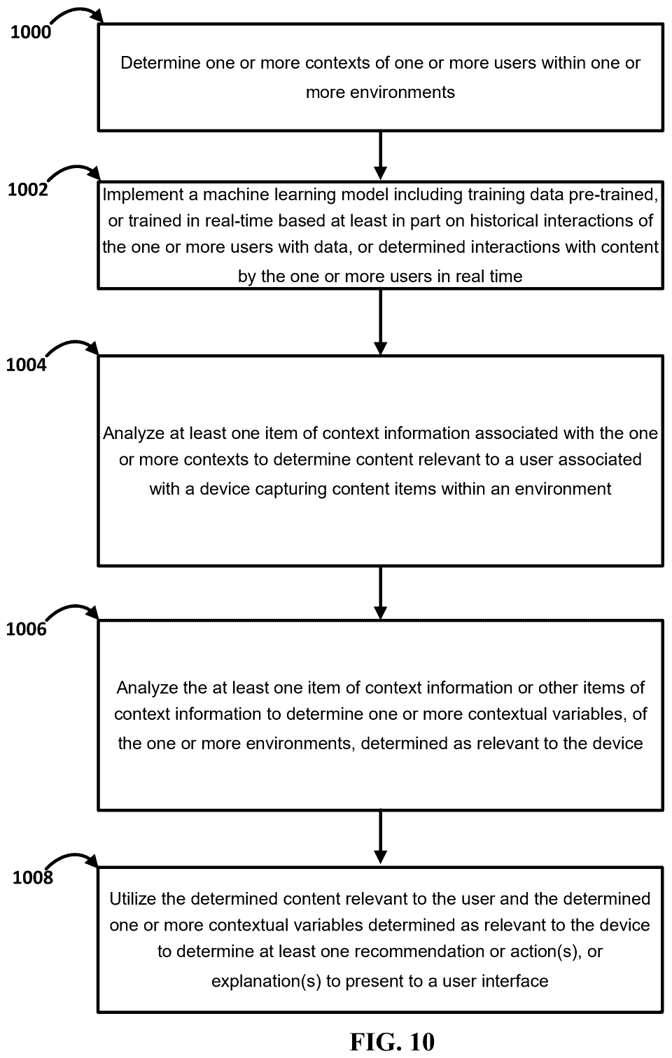

FIG. 9 illustrates an example of a machine learning framework 900 including machine learning model(s) 930 and a training database 950, in accordance with one or more examples of the present disclosure. The training database 950 may store training data 920. In some examples, the machine learning framework 900 may be hosted locally in a computing device or hosted remotely. By utilizing the training data 920 of the training database 950, the machine learning framework 900 may train the machine learning model(s) 930 to perform one or more functions, described herein, of the machine learning model(s) 930. In some examples, the machine learning model(s) 930 may be stored in a computing device. For example, the machine learning model(s) 930 may be embodied within a communication device (e.g., UE 30). In some other examples, the machine learning model(s) 930 may be embodied within another device (e.g., computing system 300). Additionally, the machine learning model(s) 930 may be processed by one or more processors (e.g., processor 32 of FIG. 2, coprocessor 81 of FIG. 3). In some examples, the machine learning model(s) 930 may be associated with operations (or performing operations) of FIG. 10. In some other examples, the machine learning model(s) 930 may be associated with other operations. In some examples, the machine learning model(s) 930 may be an example of the XAI assistant 47.

The training data 920 employed by the machine learning model(s) 930 may be pre-trained, fixed or updated periodically. Alternatively, the training data 920 may be updated in real-time based upon the evaluations performed by the machine learning model(s) 930 in a non-training mode. This may be illustrated by the double-sided arrow connecting the machine learning model(s) 930 and stored training data 920 which may be stored in the training database 950. Some other examples of the training data 920 may include, but are not limited to, items of content determined as being associated with a network (e.g., the Internet, a social network, etc.), a platform (e.g., system 100) or the like.

Some of the training data 920 of the machine learning model(s) 930 may include user data about how contextual information/variables may be mapped to various different applications and/or actions. In some example aspects, such training data may be obtained based on user data of users associated with a system (e.g., system 100). The user data may be data, information or the like involving past/historical interactions and/or current (e.g., real time) interactions of the users associated with the system. In some example aspects, these users may opt in with the system (e.g., system 100) to enable usage of user data to be utilized as training data 920.

For purposes of illustration and not of limitation, for example, the training data 920 may relate to a manner in which actions and/or recommendations map to, or are associated with, an application(s) (e.g., a recipe app, a timer app, a grocery app, etc.). The training data 920 may be utilized to train the machine learning model(s) 930 to predict/determine one or more best actions and/or best recommendations, and/or explanations to present to an adaptable user interface (e.g., adaptive UI 604) associated with a user. Additionally, as described above, the machine learning model(s) 930 may be trained at an initial stage, in real-time and/or trained periodically (e.g., updated periodically).

FIG. 10 illustrates an example flowchart illustrating operations for determining actions, recommendations, and/or explainable content to provide to an adaptable user interface according to an example of the present disclosure. At operation 1000, a device (e.g., artificial reality system 602) may determine one or more contexts of one or more users within one or more environments. At operation 1002, a device (e.g., artificial reality system 602) may implement a machine learning model (e.g., machine model(s) 930) including training data (e.g., training data 920) pre-trained, or trained in real-time based at least in part on historical interactions of one or more users with data, or determined interactions with content by one or more other users in real time.

At operation 1004, a device (e.g., artificial reality system 602) may analyze at least one item of context information associated with the one or more contexts to determine content relevant to a user associated with the device capturing content items within an environment (e.g., environment 600). The environment may be an environment of the one or more environments. At operation 1006, a device (e.g., artificial reality system 602) may analyze the at least one item of context information or other items of context information to determine one or more contextual variables, of the one or more environments, determined as relevant to the device. Optionally, operation 1004 and operation 1006 may be performed by the device implementing the machine learning model. At operation 1008, a device (e.g., artificial reality system 602) may utilize the determined content relevant to the user and the determined one or more contextual variables determined as relevant to the device to determine at least one recommendation, or action(s) or explanation(s) to present to a user interface. The user interface may be a user interface (e.g., adaptive UI 604) of the device to enable the user to view, or interact with, the at least one recommendation, or the action(s), or the explanation(s).

### Computational Approach for Optimizing Explanations

The method may focus on resolving discrepancies between what a user expects from an interface and what the interface provides. Such discrepancies may arise due to users' misconceptions of an environment or their lack of understanding about how the interface mapped context to queries. To address these issues, the system used two models: a contextual model and a system model. The system may be for example artificial reality system 602.

### Contextual Model

In a setting, the user is situated in a context, and all possible contexts are captured in the set: C ÎS. Each context is made up of m contextual variables, represented as: C:=c₁, c₂, . . . , cₙ. Each variable uses a one-hot encoding, represented by: c:=1. It is assumed that within a context C, each state c operates independently (for example, a bottle's fullness does not affect its location). Users receive an observation o based on the context, so oᵢ represents cᵢ. At every timestep the context changes according to T: S×S→[0, 1]. T is the probability of the transition from state C to C′. Similarly, O: S×Ω→[0, 1] is an observation probability function, where O(o, C′) is the probability of observing o while transitioning to C′.

As described above with reference to FIG. 7, an example method may consist of three categories of components: 1) models, 2) metrics, and 3) optimization. The context may be input to the models, the models may result in metrics, the metrics may be used for the optimization, and the optimization may output explanations in terms of the contextual variables. The first model may be an Adaptive User Interface policy that may be trained using data from a data collection user study. The second model may be a Bayesian-based mental model. Three cost functions or metrics may be the importance of a variable, the likelihood a user is surprised by an adaptation, and the difference between the user and system in terms of contextual inference(s). The linear optimization may be utilized with constraints to generate the explanations.

Given that users may not always have a direct observation of the environment, uncertainty often arises. But, through interactions and feedback (e.g., observations, o), users may refine their beliefs about the state of the environment. The system may utilize a Bayesian approach to model this refinement and assumed that users were Bayes optimal, which is a common assumption in Theory of Mind research. Two steps were taken to update a users' belief state: e.g., modelling of the user observation probability O and then usage O to update the belief of a user b.

Observation. Every timestep enables the user to make an observation (o) about the environment. o is sampled from the probability distribution O(o, a, C′). There are three possible scenarios: 1) The user observes a variable (e.g., the coffee cup is full), 2) The user observes the lack of something (e.g., notices the coffee cup is not in the kitchen), or 3) the user does not observe anything at all (e.g., an event occurred outside of the users' field of view). Furthermore, the system assumes that the measurement of the context and the measurement of the user's fixation are noisy with a known probability function δ_{c} and δ_{f} respectively, with the type of noise being the percentage of a random observation rather than the correct observation. This may be extended to, for example, a confusion matrix. In general, the probability the system makes a correct inference (κ) may be approximated as: κ=(1−δ_{c})*(1−δ_{f}).

When the user observed a contextual variable, the system modelled this as O^{(t)}(oᵢ| cᵢ)=κI_{c}_{ⁱ⁼⁼}ₒ_{ⁱ}+ (1−κ)I_{c}_{^{i!=}}ₒ_{ⁱ} (with κ when the observation (oᵢ) matched the actual contextual variable (cᵢ), and 1−κ otherwise, and/is an indicator function). This assumed that the user fully believed their own observations. If the user observed the lack of something, the system modelled this as follows.

Finally, if the user was unable to observe a state with model, the system modelled this as follows.

$${O}^{( t )} ( {o}_{i} \vert {c}_{i} ) = \{ \begin{matrix}1 - κ , & if {c}_{i} == {o}_{i} \\ κ * 1 / ( \vert {c}_{i} \vert - 1 ) , & otherwise\end{matrix} {O}^{( t )} ( {o}_{i} \vert {c}_{i} ) = \{ \begin{matrix}κ {O}^{( t - 1 )} ( {o}_{i} \vert {c}_{i} ) , & if {c}_{i} == {o}_{i} \\ 1 - κ {O}^{( t - 1 )} ( {o}_{i} \vert {c}_{i} ) & otherwise\end{matrix}$$

Belief Update. The approach herein explicitly modelled a systems' belief of a user's belief state b Î B and updated the beliefs Markovian. The system may not have computed bₛ (C) directly because the system assumed that the user may track the state of individual items rather than the context as a whole and as all possible permutations of a context would be extremely large and lead to both numerical and computational difficulties. Instead, the system performed the above computation per contextual variable c, so that b(C)=Π_{cîC}b(c), where b(c) denoted the belief distribution of the contextual variable c. Given b(c), after taking action a and receiving observation o:

$${b}^{′} ( {c}_{i}^{′} ) = η * O ( {o}_{i} \vert {c}_{i} , {a}_{i} ) {\sum }_{{c}_{i} ∈ C} α T ( {c}_{i}^{′} \vert {c}_{i} , a ) b ( {c}_{i} )$$

where η was a normalizing constant. Part of T was a power-law forgetting curve. This ensured that the agent was less certain about states it had fixated on further in the past such that, bₜ (c)=αbₜ_{_{−1}} (c) or, more generally, bₜ (c)=bₜ_{₀} (c)α^{t}. Furthermore, the approach herein assumed that the interactions with the system were far enough apart temporally that the state transitions may be randomly approximated (e.g., the current television channel is independent from the previous channel). This is easily shown by computing the limit, lim_{D→∞}T^{D}=0, where T<1 was the hypothetical probability an object stayed in the same state and D denoted time. Thus, the probability of the c being in a specific state was (1/|c|). T was thus a sparse matrix where each row was populated with 1/|c|ᵢ for the first i entries.

### System Model

Having formulated the contextual model, the approach herein created an approximation of a system's model. This model aimed to mirror how users associated their perceived context with the Adaptive UI layout. Broadly, the system approximation model has three components 1) a novice model based on a prior, representing fundamental assumptions or semantic connections, 2) an expert model, and 3) a frequency based expertise metric to shift the weight from novice to expert. The system denoted a user's predicted probability of an assigned query q given context C as M(q|b(C)).

$$M ( q \vert b ( C ) ) = e * {\underbrace{{p}_{e} ( q \vert b ( C ) )}}_{Eq . 6} + ( 1 - e ) * {\underbrace{{p}_{n} ( q \vert b ( C ) )}}_{Eq . 5}$$

### Novice.

Herein, the system assumed that the prior distribution was uniform overall possible queries, so that all queries were equally possible for every context.

pₙ(q|b(C))= [symbol] (|q|)

While the present disclosure uses this uniform distribution, future explorations may use semantically-driven priors.

### Expert.

For an expert model, the system assumed that the user was capable of forming an identical mapping between the context and the queries as the system was. Thus, the system used the same IUI policy as actual adaptations did. The method was capable of treating this as a black-box.

pₑ(q|b(C))=f_{IUI}(C)

### User Model Derived Optimization Criteria

With the contextual model as well as the system model in place, the system may determine both the surprise and difference terms. The surprise captures the mismatch in expectation between the user and the actual adaptation. The difference term encapsulates the contextual and system misunderstanding that has led to this surprise.

### Surprise: Mismatch in Expectations.

To compute the surprise factor, the system computed the summed difference between the actual query q*∈1 and the probability the user assigned to that query. If this matched exactly, the surprise was 0. If the user was unsure, the surprise was 0<s<1, depending on the level of surprisedness. If the user was wrong, the surprise was 1.

$$( C ) = {‖ M ( q \vert b ( C ) ) - {q}^{*} ‖}_{2}^{2}$$

### Difference: Contextual and System Misunderstanding

To compute the contextual variables that differed (D) between the user and the world, the system computed the element-wise squared difference for every state in each context variable. The system then flattened this matrix so that D was one-dimensional.

$$𝒟 ( C ) = {( b ( C ) - C )}^{2}$$

### Sensitivity Analysis for IUIs

If only the disparity is considered between a system's and a user's perceived context, this may not always yield relevant insights. For example, consider situations where the presence or absence of the user's laptop at work may not influence their cooking process. Even if there is a contextual difference, it may not affect the adaptive UI's behavior, because, how relevant is a laptop for the cooking process? It is this question that is sought to answer with the proposed method (e.g., or algorithm/application). The approach may assume that it may have the ability to query an adaptive algorithm/application without direct access. Accordingly, the system's modular method may be agnostic to any specific adaptive algorithm and/or application.

This global sensitivity analysis method began by sampling initial values within preset ranges for all input variables, subsequently assessing the model's outcome. Each variables' value was then individually altered while others were kept constant, with each alteration resulting in a new model outcome. This iterative process continued until all variables were adjusted. The entire sequence was repeated N times, using varying sets of initial values. The implementation tailored the techniques for computational efficacy such that the sampling always originated from the system's current context, the system sampled every state of contextual variables once, and the model outcome changes were consistently compared to the present adaptive interface. Notably, this resulted in the method of the system herein resembling a first order method, rather than a global method. This improved clarity, however, also missed more complex interactions (e.g., if two or more variables needed to change for a different adaptation). The system's approach led to a matrix I∈{0, 1} where every entry denoted whether a UI element(s) changed if that specific state of a contextual variable held true.

### Importance Metric.

An important consideration to take into account is whether it is important that a contextual variable(s) holds “True” or “not False”. For instance, is it important that the user is “Happy”, “Neutral”, or “Not Sad”, when there are multiple emotions possible. This difference is termed the valence of an explanation. To compute the importance of a contextual variable, the system may need to compute both valences so the system computed the “informatic truth” of an explanation in a given valence (see Table 1 for an example). The informatic truth captured how many states of a contextual variable the explanation correctly captured, normalized by the number of states in the contextual variable.

$${T}_{+} ( c , s ) = \frac{( 1 - I [ c , s ] )}{\vert c \vert} {\sum }_{{s}_{i} ∈ c} I [ c , {s}_{i} ] \\ {T}_{-} ( c , s ) = \frac{I [ c , s ]}{\vert c \vert} {\sum }_{{s}_{i} ∈ c} ( 1 - I [ c , {s}_{i} ] )$$

Table 1. The user may be “Happy”, “Neutral”, or “Sad”. Each row in the Table 1 denotes a different scenario. For this example, assume the user is “Happy”. Naturally, there may be no UI Differences when the method evaluates “Happy”. In Scenario A and B, there is an UI difference for “Sad”. Additionally in Scenario A, there is an UI difference for “Neutral”. Hence, in Scenario A it is important that the user is exactly happy (e.g., any deviation may result in a different UI). In Scenario B, it does not matter whether the user is “Happy” or “Neutral”, as only “Sad” may result in a UI difference. Finally, in Scenario C, their mood may not matter at all. The method computes the informatic truth of an explanation (in this Table 1 it may be limited to “Is Happy” and “Is Not Sad” for conciseness). The system computes how many variables an explanation truthfully explains, normalized by the total number of states in a contextual variable. For example, in Scenario A saying “is Happy” explains all three states correctly, whereas in Scenario B, “is Happy” only explains 2 as it does not capture the “Neutral” fully. “Is Not Sad” explains all three states correctly.

TABLE 1

| | UI Differences | | | Informatic Truth | |
|---|---|---|---|---|---|
| Scenario | Happy | Neutral | Sad | Is Happy | Is Not Sad |
| A | 0 | 1 | 1 | 3/3 | 2/3 |
| B | 0 | 0 | 1 | 2/3 | 3/3 |
| C | 0 | 0 | 0 | 0 | 0 |

Here T₊ denoted the informatic truth value of an “is” valence, while T₋ denotes an “is not” valence. The system concatenated all T₊ in a vector and then all T₋, so that the length of the final vector was twice the number of total states summed over all contextual variables. This vector is denoted as R_{Important}.

### Complexity: The Cost of Showing an Explanation

A linear regularization may be added to penalize instances with a large number of contextual explanations.

[symbol]

(n)=−b*n

where b was a constant that may be determined empirically. In this case, the system may not have been working in a time-domain so the system treated b as a weighting constant, where a large b correlated with less explanations being presented to the user.

### Integer Linear Programming for Explainable AI

To select the final subset of contextual variables to explain to the user, the system optimized the over the difference and importance terms. Furthermore, the system used “surprise” (S) as a weighting factor (e.g., if the user was surprised at all the system may not explain anything; if the user was maximally surprised the system showed more explanations). For novices, the system focused on the importance of variable I. For experts, the system multiplied the difference with importance (D*I), to obtain a term that was maximum when the contextual variable differed and was important, and 0 when it was not different or important. The system traded this off with a complexity cost term that penalized larger numbers of explanations. These terms were combined into an integer linear programming optimization with a decision variable x, where if xᵢ=1 the system explained contextual variable cᵢ. Finally, the system added a constraint that the number of contextual variables explained may never exceed a pre-determined amount, N.

${maximize}_{x} 𝒮 ( C ) * {\sum }_{i} ( {𝒥}_{i} ( C ) * ( 1 - e ) + ( e * \sqrt{{𝒥}_{i} ( C ) * {𝒟}_{i} ( C ) )} ) {x}_{i} + 𝒞 ( {\sum }_{i} {x}_{i} )$

| | |
|---|---|
| $subject to : i ∈ \{ 0 , … , 2 {\sum }_{c ∈ C} \vert c \vert \}$ | (Number of states times two, due to valence) |
| ${\sum }_{i} {x}_{i} \leq N$ | (Max. Explanation Constraint) |
| ${\sum }_{j ∈ c} {x}_{j} \leq 1$ | (Only one per context variable) |
| xᵢ ∈{0,1} ∀i | (Decision Variable) |

### ALTERNATIVE EMBODIMENTS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
determining one or more contexts of one or more users within one or more environments;
implementing a machine learning model comprising training data pre-trained, or trained in real-time based on historical interactions of one or more other users with data, or determined interactions with content by the one or more other users in real time;
analyzing at least one item of context information associated with the one or more contexts to determine content relevant to a user associated with an apparatus capturing content items within an environment;
analyzing the at least one item of context information or other items of context information to determine, by implementing the machine learning model, one or more contextual variables, of the one or more environments, determined as relevant to the apparatus; and
utilizing the determined content relevant to the user and the determined one or more contextual variables determined as relevant to the apparatus to determine recommendation or action to present to a user interface.

2. The method of claim 1, wherein the apparatus comprises a head mounted device.

3. The method of claim 1, further comprising:
determining whether the at one at least one item of context information and the one or more contextual variables are relevant or irrelevant associated with presentation via the user interface.

4. The method of claim 3, further comprising:
determining that the at one at least one item of context information and the one or more contextual variables are relevant in response to determining that corresponding determined scores, associated with the at one at least one item of context information and the one or more contextual variables, equal or exceed a predetermined threshold.

5. The method of claim 3, further comprising:
generating explainable data associated with at least one item of context information or at least a subset of the one or more items of contextual variables that are determined relevant for the presentation.

6. The method of claim 5, further comprising:
presenting the explainable data to the user interface to enable the user to view, or interact with, the explainable data.

7. The method of claim 1, further comprising:
determining that the content relevant to the user is beneficial for the user to consider for presentation via the user interface even though the user is unaware of the content relevant to the user.

8. The method of claim 1, further comprising:
generating at least one application associated with the determined at least one recommendation to present via the user interface.

9. The method of claim 8, further comprising:
generating at least one task associated with the action and the application to present via the user interface.

10. The method of claim 1, further comprising:
determining that the determined one or more contextual variables determined as relevant to the apparatus comprises detected information associated with a second user associated with a same environment associated as the environment associated with the user or another environment of the one or more environments.

11. An apparatus comprising:
one or more processors; and
at least one memory storing instructions, that when executed by the one or more processors, cause the apparatus to:
determine one or more contexts of one or more users within one or more environments;
implement a machine learning model comprising training data pre-trained, or trained in real-time based on historical interactions of one or more users with data, or determined interactions with content by the one or more users in real time;
analyze at least one item of context information associated with the one or more contexts to determine content relevant to a user associated with the apparatus capturing content items within an environment;
analyze the at least one item of context information or other items of context information to determine, by implementing the machine learning model, one or more contextual variables, of the one or more environments, determined as relevant to the apparatus; and
utilize the determined content relevant to the user and the determined one or more contextual variables determined as relevant to the apparatus to determine at least one recommendation or action to present to a user interface.

12. The apparatus of claim 11, wherein the apparatus comprises a head mounted device.

13. The apparatus of claim 11, wherein when the one or more processors execute the instructions, the apparatus is configured to:
determine whether the at one at least one item of context information and the one or more contextual variables are relevant or irrelevant associated with presentation via the user interface.

14. The apparatus of claim 13, wherein when the one or more processors execute the instructions, the apparatus is configured to:
determine that the at one at least one item of context information and the one or more contextual variables are relevant in response to determining that corresponding determined scores, associated with the at one at least one item of context information and the one or more contextual variables, equal or exceed a predetermined threshold.

15. The apparatus of claim 13, wherein when the one or more processors execute the instructions, the apparatus is configured to:
generate explainable data associated with at least one item of context information or at least a subset of the one or more items of contextual variables that are determined relevant for the presentation.

16. The apparatus of claim 15, wherein when the one or more processors execute the instructions, the apparatus is configured to:
present the explainable data to the user interface to enable the user to view, or interact with, the explainable data.

17. The apparatus of claim 11, wherein when the one or more processors execute the instructions, the apparatus is configured to:
determine that the content relevant to the user is beneficial for the user to consider for presentation via the user interface even though the user is unaware of the content relevant to the user.

18. A non-transitory computer-readable medium storing instructions that, when executed, cause:
determining one or more contexts of one or more users within one or more environments;
implementing a machine learning model comprising training data pre-trained, or trained in real-time based at least in part on historical interactions of one or more users with data, or determined interactions with content by the one or more users in real time;
analyzing at least one item of context information associated with the one or more contexts to determine content relevant to a user associated with an apparatus capturing content items within an environment;
analyzing the at least one item of context information or other items of context information to determine, by implementing the machine learning model, one or more contextual variables, of the one or more environments, determined as relevant to the apparatus; and
utilizing the determined content relevant to the user and the determined one or more contextual variables determined as relevant to the apparatus to determine at least one recommendation or action to present to a user interface.

19. The computer-readable medium of claim 18, wherein the instructions, when executed, further cause:
determining whether the at one at least one item of context information and the one or more contextual variables are relevant or irrelevant associated with presentation via the user interface.

20. The computer-readable medium of claim 18, wherein the instructions, when executed, further cause:
determining that the content relevant to the user is beneficial for the user to consider for presentation via the user interface even though the user is unaware of the content relevant to the user.
